(19) United States
(12) Patent Application Publication
(10) Pub. No.: US 2026/0188837 A1
(43) Pub. Date: Jul. 2, 2026

(54) BATTERY MODULE AND BATTERY PACK INCLUDING THE SAME

(71) Applicant: SK On Co., Ltd., Seoul (KR)

(72) Inventors: A Ra JO, Daejeon (KR); Yun Joo NOH, Daejeon (KR); Gang U LEE, Daejeon (KR)

(21) Appl. No.: 19/433,991

(22) Filed: Dec. 29, 2025

(30) Foreign Application Priority Data
Dec. 31, 2024 (KR) 10-2024-0202237

(51) Int. Cl. H01M 50/383; A62C 3/06; A62C 3/07; A62C 3/16; H01M 50/202; H01M 50/211; H01M 50/271; H01M 50/289; H01M 50/342; H01M 50/673

(52) U.S. Cl. CPC H01M 50/383; A62C 3/16; H01M 50/202; H01M 50/211; H01M 50/271; H01M 50/289; H01M 50/342; H01M 50/673; A62C 3/06; A62C 3/07; H01M 2200/10

(57) ABSTRACT

The present disclosure provides a battery module including: a cell assembly including a plurality of battery cells; a housing including a first housing covering the cell assembly and a second housing in which the cell assembly is disposed; and a fire extinguishing member disposed on one surface of the first housing. The first housing includes a vent opening for discharging gas generated by the cell assembly, and the fire extinguishing member covers at least a portion of the vent opening.

### CROSS-REFERENCE TO RELATED APPLICATION(S)

This patent document claims the priority and benefits of Korean Patent Application No. 10-2024-0202237 filed on Dec. 31, 2024, the disclosure of which is incorporated herein by reference in its entirety.

### TECHNICAL FIELD

The present disclosure relates to a battery module and a battery pack including the same.

### BACKGROUND

Unlike primary batteries, secondary batteries may be charged with and discharged of electricity, and thus may be applied to various fields such as digital cameras, mobile phones, laptop computers, hybrid vehicles, and electric vehicles. Examples of secondary batteries include nickel-cadmium batteries, nickel-metal hydride batteries, nickel-hydrogen batteries, and lithium secondary batteries.

Such secondary batteries are stacked in plural to form a cell assembly, which are then disposed within a housing to form a portion of a battery device, such as a battery module or battery pack.

### SUMMARY

Battery cell fire may occur under a variety of conditions, including when a battery cell reaches an end of a lifespan thereof, when a battery cell experiences swelling, when a battery cell is overcharged, when a battery cell is exposed to heat, when a sharp object such as a nail penetrates through an external material of the battery cell, or when a battery cell is subjected to external impact. Flames or high-temperature gases emitted from the battery cell may cause a chain reaction of fires in adjacent battery cells accommodated in the battery device, and may potentially trigger a thermal propagation situation.

Specifically, if flames, high-temperature gases, and conductive particles emitted from battery cells flow freely within the battery module, there may be a risk that they could directly ignite adjacent battery cells or cause short circuits between battery module components, further exacerbating this thermal propagation situation.

Accordingly, a discharge structure capable of appropriately discharging flames or high-temperature gases emitted from a battery cell without affecting other battery cells is required. Furthermore, a fire extinguishing structure capable of extinguishing such flames or high-temperature gases is also required.

According to an aspect of the present disclosure, a battery module including a discharge structure capable of discharging flames or gases generated by a battery cell may be provided.

According to one aspect of the present disclosure, a battery module including a fire extinguishing structure capable of extinguishing flames or gases generated by a battery cell may be provided.

A battery module of the present disclosure and a battery pack including the same may be widely applied to electric vehicles, battery charging stations and green technology fields such as solar power generation and wind power generation using other batteries. Furthermore, the battery module of the present disclosure and the battery pack including the same may be used in eco-friendly electric vehicles, hybrid vehicles, and other vehicles that prevent climate change by suppressing air pollution and greenhouse gas emissions.

A battery module according to the present disclosure may include: a cell assembly including a plurality of battery cells; a housing including a first housing covering the cell assembly and a second housing in which the cell assembly is disposed; and a fire extinguishing member disposed on one surface of the first housing, and the first housing may include a vent opening for discharging gas generated by the cell assembly, and the fire extinguishing member may cover at least a portion of the vent opening.

According to an embodiment, the vent opening may include a first portion not covered by the fire extinguishing member and a second portion covered by the fire extinguishing member.

According to an embodiment, the fire extinguishing member may include: a case in which an internal space is formed; and a fire extinguishing fluid accommodated in the internal space.

According to an embodiment, the case may be formed of a material having a melting point of 100° C. or higher.

According to an embodiment, the fire extinguishing fluid may include at least one of potassium carbonate, ammonium carbonate, urea, first ammonium phosphate, second ammonium phosphate, third ammonium phosphate, or purified water.

According to an embodiment, the fire extinguishing member may include: a body portion that does not cover the vent opening; and a cover portion connected to the body portion and covering the vent opening, and a thickness of one surface of the cover portion facing the cell assembly is thinner than a thickness of the other surface thereof.

According to an embodiment, a length of the cover portion in a second direction, perpendicular to a first direction in which battery cells of the cell assembly are arranged, is less than a length of the vent opening in the second direction.

According to an embodiment, the cover portion may have a shape protruding in a direction facing the cell assembly.

According to an embodiment, the vent opening may include a pair of vent openings spaced apart from each other in a second direction, perpendicular to a first direction in which battery cells of the cell assembly are arranged in the first housing.

According to an embodiment, the vent opening may be disposed adjacently to an electrode tab of the cell assembly in the first housing.

According to an embodiment, the vent opening may have a shape extending in a first direction in which battery cells of the cell assembly are arranged.

A battery pack according to the present disclosure may include: at least one battery module; and a pack housing accommodating the battery module, and the at least one battery module may include: a cell assembly including a plurality of battery cells; a housing including a first housing covering the cell assembly and a second housing in which the cell assembly is disposed; and a fire extinguishing member disposed on one surface of the first housing, and the first housing may include a vent opening for discharging gas generated by the cell assembly, and the fire extinguishing member may cover a portion of the vent opening.

According to an embodiment, the fire extinguishing member may include: a case in which an internal space is formed; and a fire extinguishing fluid accommodated in the internal space.

According to an embodiment, the battery pack may comprise: a battery controller connected to the at least one battery module.

According to an embodiment, the pack housing may include at least one frame that partitions a space in which the at least one battery module is accommodated into a plurality of spaces, and wherein the pack housing accommodates a plurality of battery modules.

According to an example embodiment of the present disclosure, a battery module including a discharge structure capable of discharging flames or gases generated by a battery cell may be provided.

According to an example embodiment of the present disclosure, a battery module including a fire extinguishing structure capable of extinguishing flames or gases generated by a battery cell may be provided.

### BRIEF DESCRIPTION OF DRAWINGS

Certain aspects, features, and advantages of the present disclosure are illustrated by the following detailed description with reference to the accompanying drawings.

FIG. 1 is a perspective view of a battery module according to an example embodiment;

FIG. 2 is an exploded perspective view of a battery module according to an example embodiment;

FIG. 3 is a top plan view of a battery module according to an example embodiment;

FIG. 4 is a perspective view of a battery cell according to an example embodiment;

FIG. 5 is a partially cutaway perspective view of a battery module according to an example embodiment;

FIG. 6 is a cross-sectional view taken along line I-I′ of FIG. 1; and

FIG. 7 is a plan view of a battery pack according to an example embodiment.

### DETAILED DESCRIPTION

The same reference numbers or symbols used in each drawing attached to this specification represent parts or components that perform substantially the same functions. For convenience of explanation and understanding, the same reference numbers or symbols may be used in different embodiments. In other words, even if components having the same reference number are depicted in a plurality of drawings, the plurality of drawings do not all represent an embodiment.

In the following description, the singular also includes the plural unless specifically stated otherwise in the phrase. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Furthermore, hereinafter, it should be noted in advance that the expressions such as “above,” “upper,” “below,” “beneath,” “lower,” “side,” “front,” and “rear” are based on the direction illustrated in the drawings, and may be expressed differently if the direction of the object is changed.

In addition, in the present specification and claims, terms including ordinal numbers such as “first” and “second” may be used to distinguish between components. These ordinal numbers are used to distinguish the same or similar components from each other, and the meaning of the terms should not be construed as limited by the use of these ordinal numbers. For example, the components combined with these ordinal numbers should not be construed as limiting the order of use or arrangement of the components. If necessary, the ordinal numbers may be used interchangeably.

Hereinafter, the present disclosure will be described in detail with reference to the attached drawings. However, these are merely exemplary and the present disclosure is not limited to the specific embodiments described as examples.

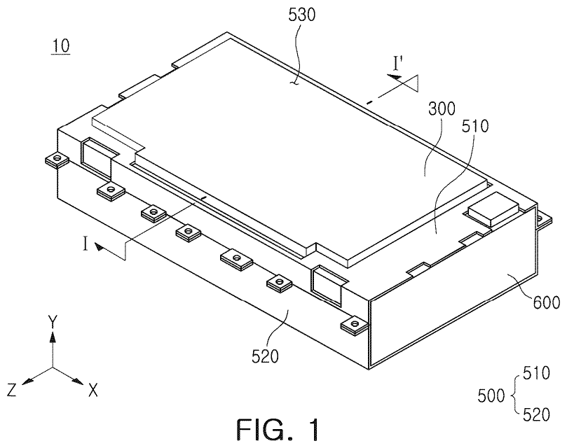

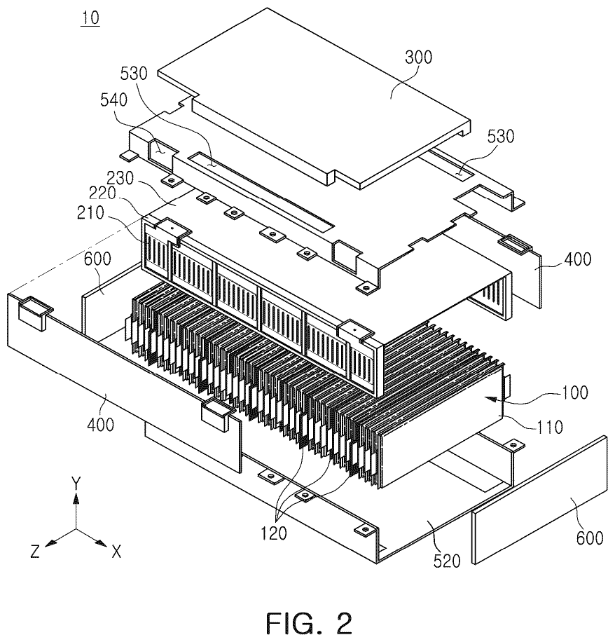

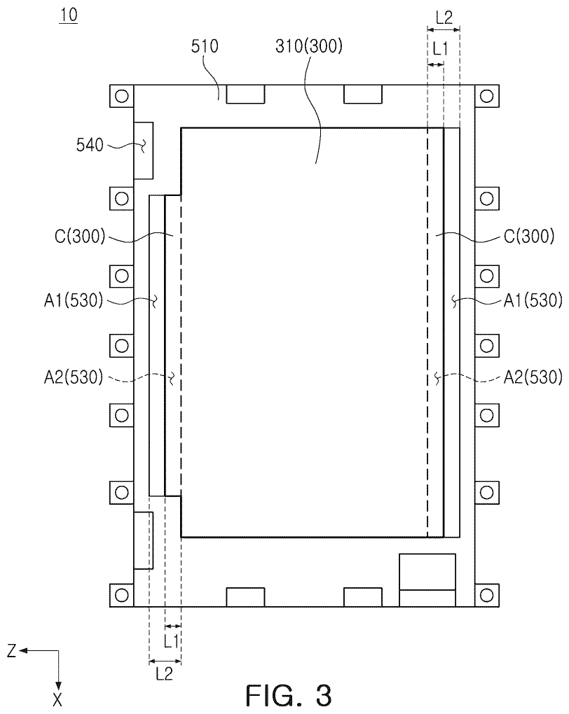

FIG. 1 is a perspective view of a battery module 10 according to an embodiment. FIG. 2 is an exploded perspective view of a battery module 10 according to an embodiment. FIG. 3 is a plan view of the battery module 10 according to an embodiment, when viewed from above.

Referring to FIGS. 1 and 2, a battery module 10 according to the present disclosure may include a cell assembly 100 including a plurality of battery cells 110, and a housing 500 including a first housing 510 covering the cell assembly 100 and a second housing 520 in which the cell assembly 100 is disposed.

Furthermore, the battery module 10 according to an embodiment may include a busbar assembly 200 electrically connected to the battery cells 110, and an end cover coupled to at least one side of the housing 500.

The cell assembly 100 may be configured with a plurality of battery cells 110 arranged in one direction (e.g., an X-axis direction of FIG. 2). In the following description, the direction in which the battery cells 110 are arranged is referred to as a first direction (X-axis direction, hereinafter referred to as “X”) or a cell arrangement direction.

The respective battery cells 110 included in the cell assembly 100 may be configured as a secondary battery. For example, the battery cell 110 may be configured as a lithium secondary battery, a nickel-cadmium battery, a nickel-metal hydride battery, a nickel-hydrogen battery, or the like.

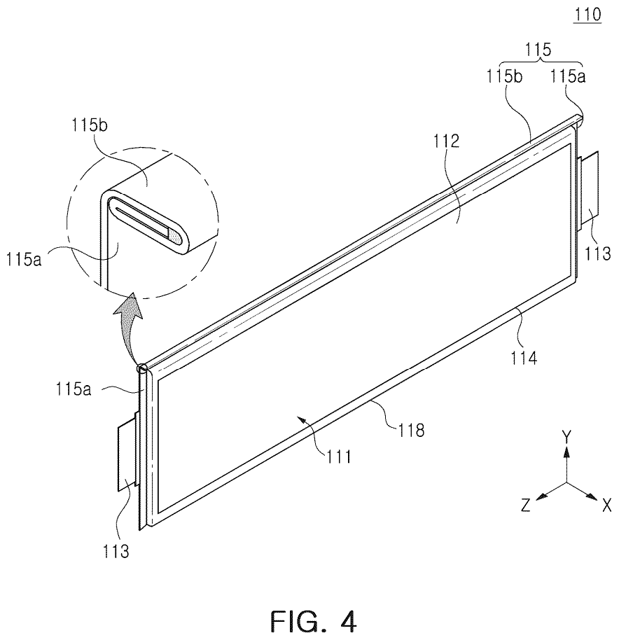

The battery cell 110 may be configured as a pouch-type secondary battery in which an electrode assembly (114 of FIG. 4) is accommodated in a pouch 111 (see FIG. 4). In the detailed description of the invention, a pouch-type secondary battery is used as an example of the battery cell 110, but in the detailed description of the invention and the claims, the battery cell 110 does not exclude a can-type secondary battery. A can-type secondary battery is a secondary battery in which an electrode assembly is accommodated within a rigid casing, and depending on an external shape thereof, the can-type secondary battery may be classified as a cylindrical secondary battery or a square secondary battery. In other words, both square secondary batteries and cylindrical secondary batteries may be included in the battery cell 110 of the present disclosure. The battery cells 110 may be electrically connected to each other via a busbar assembly 200. At least a portion of the busbar assembly 200 may be disposed to face the cell assembly 100 in a direction, perpendicular to the cell arrangement direction.

According to an embodiment, the busbar assembly 200 may include a busbar 210 electrically connecting one battery cell 110 to another battery cell 110 and a busbar frame 220 supporting the busbar 210.

The busbar 210 may be formed of a conductive material (e.g., metal) and may serve to electrically connect the battery cells 110 to each other. The busbar 210 may be electrically connected to a lead tab 113 of the battery cell 110 by bonding to each other. Various welding methods, including laser welding, may be used to connect the busbar 210 and the lead tab 113 (see FIG. 4). However, the connection method is not limited to welding, and any method that may electrically connect two metallic materials may be used.

The busbar 210 may face the cell assembly 100 in a direction (e.g., the Z-axis direction), perpendicular to a first direction (X-direction). In the following description, a direction in which the busbar 210 and the cell assembly 100 face each other is defined as a second direction (Z-axis direction, hereinafter referred to as ‘Z’). Additionally, a direction, perpendicular to both the first direction (X-direction) and the second direction (Z-direction), is defined as a third direction (Y-axis direction, hereinafter referred to as ‘Y’). For example, the third direction (Y-direction) may be a height direction of the battery module 10, and may be a direction in which the first housing 510 and the second housing 520 face each other.

According to an embodiment, the busbar assembly 200 may include a terminal portion that may be electrically connected to a circuit external to the battery module 10. The terminal portion may be exposed to an outside of the battery module 10 through an opening 540 of the housing 500.

The busbar frame 220 may structurally support the busbar 210 even under external shock or vibration conditions. For example, the busbar frame 220 may include a lightweight plastic material with excellent mechanical strength, such as polypropylene, polybutylene terephthalate, or modified polyphenylene oxide (MPPO). This material may structurally support the busbar 210 while ensuring insulation.

The busbar 210 may be secured to the busbar frame 220 using various methods. For example, the busbar 210 may be secured to the busbar frame 220 using a heat-bonding process or an insert injection process.

In an embodiment, the busbar assembly 200 may further include a connecting frame 230 disposed between the cell assembly 100 and the first housing 510 and connected to the busbar frame 220. For example, the busbar assembly 200 may include a pair of busbar frames 220 facing each other in the second direction (Z-direction) with the cell assembly 100 interposed therebetween, and a connecting frame 230 connected to the pair of busbar frames 220 and facing the cell assembly 100 in the third direction (Y-direction).

In an embodiment, a sensing module (not illustrated) capable of detecting a status of the cell assembly 100 may be disposed on the connecting frame 230. The sensing module (not illustrated) may include a temperature sensor and a voltage sensor. A sensing module (not illustrated) may sense the status of a battery cell 110 and may output the sensed information to the outside of the battery module 10.

The housing 500 provides an internal space in which one or more cell assemblies 100 may be accommodated. The housing 500 may be formed of a material having a predetermined rigidity to protect the cell assemblies 100 and other electrical components accommodated therein from external impact. For example, the housing 500 may include a metal material such as aluminum.

According to an embodiment, the housing 500 may include a first housing 510 covering the cell assemblies 100 and a second housing 520 in which the cell assemblies 100 are disposed. However, a structure of the housing 500 is not limited thereto, and any shape may be used as long as the housing 500 has an internal space capable of accommodating at least one cell assembly 100. For example, the housing 500 may be configured as an integrated monoframe in which the first housing 510 and the second housing 520 are integrally formed and both side surfaces thereof are open.

According to an embodiment, the first housing 510 may include a vent opening 530 for discharging gas generated by the cell assembly 100. For example, the vent opening 530 may include a pair of vent openings 530 spaced apart from each other in the second direction (Z-direction), perpendicular to the first direction (X-direction) in which the battery cells 110 of the cell assembly 100 are arranged in the first housing 510. Accordingly, the vent opening 530 may be disposed adjacently to the electrode tab of the cell assembly 100 in the first housing 510. Unlike a central portion of the cell assembly 100, a portion surrounding the electrode tabs of the cell assembly 100 includes a large amount of empty space, allowing for increased movement of flames and gases, and thus, since the vent opening 530 is disposed adjacently to the electrode tabs of the cell assembly 100, flames or gases generated within the cell assembly 100 may be quickly discharged to the outside through the vent opening 530.

The vent opening 530 may have a shape of openings penetrating through the first housing 510. For example, the vent opening 530 may include a shape extending in the first direction (X-direction). Accordingly, the vent opening 530 may have a larger area than conventional discontinuously formed vent openings, thereby allowing for greater discharge of gas and flames.

A pair of vent openings 530 may have the same shape and size, but may differ in size depending on an arrangement with other components (e.g., terminal portions). For example, considering the arrangement of the terminal portion, the vent opening 530 on one side may have a shorter length in the first direction (X-direction) than that of the vent opening 530 on the other side.

According to an embodiment, a shielding member may be disposed in the vent opening 530. The shielding member may be comprised of a thin film or a sheet, and may block foreign substances from entering from the outside of the battery module 10. The shielding member may include a lightweight material having excellent impact resistance, excellent heat resistance, or excellent electrical insulation. For example, the shielding member may include a polycarbonate sheet. In the event of thermal propagation of the battery module 10, at least a portion of the shielding member may be torn, thus allowing gas emitted from the cell assembly 100 to pass through appropriately.

An end cover 600 may be coupled to one open side of the housing 500. For example, as illustrated in FIG. 2, the end covers 600 may be provided in a pair and connected to both open sides of the housing 500, respectively.

According to an embodiment, in order to prevent electrical shorting between the busbar assembly 200 and the housing 500, the battery module 10 may include an insulating cover 400. For example, the insulating cover 400 may be disposed to face the busbar assembly 200 between the busbar assembly 200 and the housing 500. The insulating cover 400 may include an insulating material, thus preventing electrical connection between the busbar assembly 200 and the housing 500. For example, the insulating cover 400 may be formed of a plastic injection molded material, such as polypropylene or modified polyphenylene oxide (MPPO). However, the material of the insulating cover 400 is not limited thereto. As the insulating cover 400 is disposed, an electrical short circuit may be prevented from occurring between the cell assembly 100 and the housing 500, or between the busbar 210 and the housing 500.

In an embodiment, a heat dissipation member (not illustrated) may be disposed between the cell assembly 100 and the housing 500. One surface of the heat dissipation member (not illustrated) may be in contact with the cell assembly 100, and the other surface, opposite to the one surface, may be in contact with the housing 500. The heat dissipation member (not illustrated) may be provided using a thermally conductive adhesive or thermal adhesive. The heat dissipation member (not illustrated) may fill a space between the cell assembly 100 and the housing 500, thereby promoting heat transfer through conduction. Accordingly, the heat dissipation efficiency of the battery module 10 may be increased.

When a large number of battery cells 110 are disposed within the battery module 10, there is a risk that an event occurring in one battery cell 110 may be transmitted in a chain reaction to other battery cells 110. Furthermore, high-temperature gas or flames generated by the battery cell 110 may flow irregularly around the cell assembly 100, and may potentially impact the battery module 10. Alternatively, conductive particles flying along with the gas or flames may cause short circuits to occur between components within the battery module 10 (e.g., between a plurality of busbars). Furthermore, in a process in which gas or flames flow in areas adjacent to the cell assembly 100, the gas or flames may form unintended heat propagation paths, resulting in potentially exacerbating thermal propagation.

In order to prevent this issue, the battery module 10 according to an embodiment may include a plurality of heat blocking members 120. For example, the cell assembly 100 may include heat blocking members 120 disposed between battery cells 110. The heat blocking members 120 may prevent heat propagation between the battery cells 110 adjacent to each other. The thermal blocking member 120 may protect the battery cells 110 from physical and thermal shocks. For example, the thermal blocking member 120 may be configured to block heat propagation from one battery cell 110 to another battery cell 110, while also absorbing the expansion pressure of the battery cells 110.

The plurality of thermal blocking members 120 may guide a movement path of gas or flame around the cell assembly 100 in a predetermined direction in a thermal propagation situation. For example, the thermal blocking members 120 disposed between the battery cells 110 may guide the gas or flames to flow toward an upper end of the battery module 10.

Referring to FIG. 3, the battery module 10 according to the present disclosure may include a fire extinguishing member 300 disposed on one surface of the first housing 510. A fire extinguishing fluid 320 included in the fire extinguishing member 300 may be sprayed into the battery module 10 through the vent opening 530. Accordingly, the fire extinguishing member 300 may suppress gas and flames when an event occurs in the battery cell 110, thereby preventing a chain reaction of thermal propagation.

One surface of the first housing 510 on which the fire extinguishing member 300 is disposed may refer to a surface opposite to a surface of the first housing 510 facing the cell assembly 100. For example, the surface may refer to an upper surface of the first housing 510.

At least a portion of the fire extinguishing member 300 may cover a portion of the vent opening 530. Specifically, the fire extinguishing member 300 may include a body portion 310 that does not cover the vent opening, and a cover portion C connected to the body portion 310 and covering the vent opening 530.

The cover portion C refers to a portion of the fire extinguishing member 300 that covers the vent opening 530, and the body portion 310 may refer to the remaining portion of the fire extinguishing member 300 excluding the cover portion C.

Corresponding to the pair of vent openings 530 being spaced apart from each other in the second direction (Z-direction), the cover portion C may also include a pair of cover portions C formed in the fire extinguishing member 300 spaced apart from each other in the second direction (Z-direction). In this case, the body portion 310 may be formed between the pair of cover portions C.

Furthermore, since the vent opening 530 includes a shape extending in the first direction (X-direction), the cover portion C may also include a shape extending in the first direction (X-direction).

As the pair of vent openings 530 may have different sizes, the pair of cover portions C may also have different sizes. For example, the vent opening 530 on one side may have a shorter length in the first direction (X-direction) than the vent opening 530 on the other side due to the arrangement of the terminal portions, and correspondingly, the cover portion C on one side may have a shorter length in the first direction (X-direction) than the cover portion C on the other side.

The length of the cover portion C in the first direction (X-direction) may be less than or equal to the length of the vent opening 530 in the first direction (X-direction). A length L1 of the cover portion C in the second direction (Z-direction) may be less than a length L2 of the vent opening 530 in the second direction (Z-direction). For example, the length of the cover portion C in the first direction (X-direction) may be equal to the length of the vent opening 530 in the first direction (X-direction), and the length L1 in the second direction (Z-direction) may be less than the length L2 of the vent opening 530 in the second direction (Z-direction). Accordingly, the vent opening 530 may include a first portion A1 not covered by the cover portion C of the fire extinguishing member 300 and a second portion A2 covered by the cover portion C. Since the first portion A1 is not covered by the cover portion C, the first portion A1 may have the shape of an open opening. That is, in a state in which the fire extinguishing member 300 is disposed on one surface of the first housing 510, the first portion A1 may serve as a passage connecting an interior and an exterior of the battery module 10. Accordingly, the flames or gas within the battery module 10 may be immediately discharged to the exterior through the first portion A1, preventing a thermal propagation situation from spreading in a chain reaction. In other words, when the vent opening 530 is entirely covered by the fire extinguishing member 300, the gas or flames within the battery module 10 may not be discharged to the outside until the fire extinguishing member 300 melts. Accordingly, the gas or flames may be transferred to adjacent battery cells 110 or increase the internal pressure of the battery module 10, thus potentially causing an explosion. However, in the case of the present disclosure, since the gas or flames may be immediately discharged to the outside through the first portion A1, the thermal propagation prevention effect and explosion prevention effect are superior.

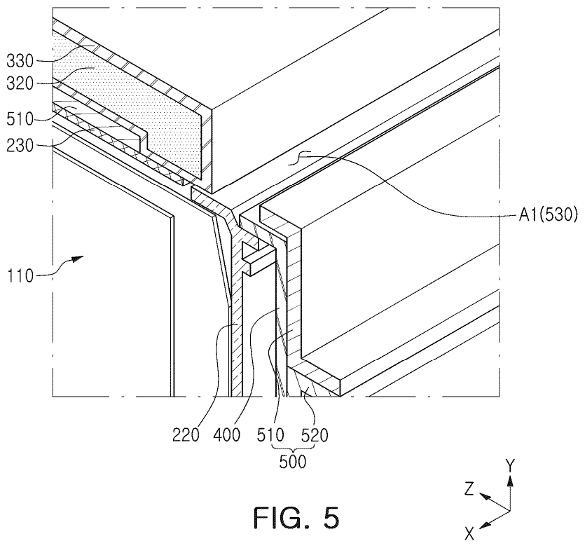

A detailed description of the fire extinguishing member 300 will be described below with reference to FIGS. 4 and 5.

FIG. 4 is a perspective view of a battery cell 110 according to an embodiment.

Referring to FIG. 4, the battery cell 110 may be a pouch-type secondary battery having an electrode assembly 114 accommodated within a pouch 111.

In a pouch 111—type secondary battery, the electrode assembly 114 and an electrolyte (not illustrated) may be accommodated within the pouch 111 formed by forming one or more outer materials. For example, the pouch 111 may be formed by forming one or two storage compartments onto a single outer layer, and then folding the outer layer so that the storage compartments form a single space.

The pouch 111 may include: an electrode accommodating portion 112 in which the electrode assembly 114 and an electrolyte (not illustrated) are accommodated, a sealing portion 115 formed around the electrode accommodating portion 112, and a lead tab 113 electrically connected to the electrode assembly 114 and exposed to the outside of the pouch 111.

The electrode accommodating portion 112 provides an internal space in which the electrode assembly 114 and the electrolyte (not illustrated) are accommodated. The electrode assembly 114 may be formed by stacking a plurality of cathode plates and a plurality of anode plates with a separator interposed therebetween.

The sealing portion 115 formed by bonding the pouch 111 along at least a portion of a periphery of the electrode accommodating portion 112 may be disposed. A thermal fusion method may be used for bonding the pouch 111, but the present disclosure is not limited thereto.

The sealing portion 115 may include a first sealing portion 115a formed in a portion in which the lead tab 113 is disposed, and a second sealing portion 115b formed in a portion in which the lead tab 113 is not disposed.

In order to increase the bonding reliability of the sealing portion 115 and minimize an area of the sealing portion 115, as illustrated in the partially enlarged view of FIG. 4, the sealing portion 115 may be formed in a folded shape at least one time.

In the battery cell 110, when a single sheet of outer material is folded to enclose the electrode assembly 114, there is no need to form a sealing portion in the portion in which the outer material is folded. In this case, as illustrated in FIG. 4, the sealing portion 115 may be formed on only three sides of an outer periphery of the electrode accommodating portion 112, and a folding portion 118 may be formed on one surface of the outer periphery of the electrode accommodating portion 112.

However, the structure of the battery cell 110 is not limited to the above-described configuration. For example, the electrode accommodating portion 112 may be formed by overlapping two outer layers, and sealing portions may be formed on all four sides surrounding the electrode accommodating portion 112.

Furthermore, the battery cell 110 applied to the battery module 10 of embodiments is not limited to the pouch-type secondary battery described above. For example, the battery cell 110 may be configured as a square can-type secondary battery, or may also be formed as a bundle by grouping a plurality of pouch-type secondary batteries.

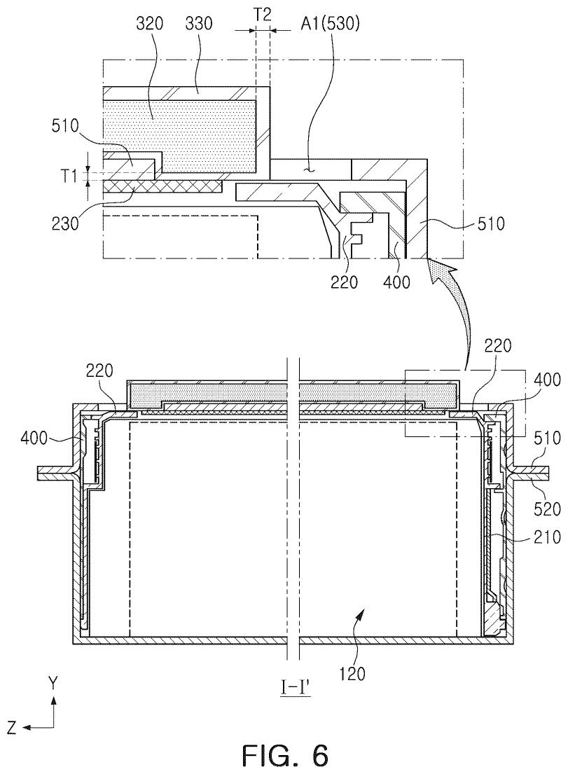

FIG. 5 is a partial cutaway perspective view of a battery module 10 according to an embodiment. FIG. 6 is a cross-sectional view taken along line I-I′ of FIG. 1.

The descriptions of the cell assembly 100, the busbar assembly 200, the fire extinguishing member 300, the insulating cover 400, and the housing 500 of FIGS. 1 to 4 may also be applied to the cell assembly 100, the busbar assembly 200, the fire extinguishing member 300, the insulating cover 400, and the housing 500 of FIGS. 5 and 6.

Referring to FIGS. 5 and 6, the fire extinguishing member 300 according to an embodiment may include a case 330 forming an internal space and a fire extinguishing fluid 320 accommodated in the internal space.

The case 330 may be formed of a material having a melting point of 100° C. or higher, 160° C. or higher, 180° C. or higher, or 250° C. or higher. Accordingly, the case 330 does not melt under the typical high temperature conditions (approximately 80° C.) of the battery cell 110, and may melt only under abnormally high temperatures.

For example, the case 330 may include at least one of polypropylene (PP), polycarbonate (PC), acrylic, or polyvinyl chloride (PVC).

The case 330 may melt due to flames or gas generated under abnormally high temperatures of the battery cell 110, and the fire extinguishing fluid 320 accommodated within the internal space of the case 330 may flow into the interior of the battery module 10.

The fire extinguishing fluid 320 may be a material having at least one of a catalytic effect, a suffocating effect, or a cooling effect. The catalytic effect may refer to slowing or inhibiting a chemical reaction. The suffocation effect may refer to stopping combustion by cutting off the oxygen supply during the fire suppression or extinguishing process. The cooling effect may refer to lowering a temperature by absorbing or removing heat during the fire suppression process. Accordingly, in a thermal propagation situation, the fire extinguishing fluid 320 may prevent an event of a battery cell 110 from spreading to the battery cells 110 adjacent to each other.

For example, the fire extinguishing fluid 320 may include at least one of potassium carbonate, ammonium carbonate, urea, primary ammonium phosphate, secondary ammonium phosphate, tertiary ammonium phosphate, or purified water.

According to an embodiment, a thickness T1 of one surface of the cover portion C facing the cell assembly 100 may be thinner than a thickness T2 of the other surface. Accordingly, when the cover portion C is exposed to flames or gas from the battery cell 110, one surface melts before the other surface, so that the fire extinguishing fluid 320 may flow consistently toward the battery cell 110 without scattering in other directions.

For example, the thickness T2 of the other surface may be at least two times, at least 2.5 times, or at least three times the thickness T1 of the one surface.

According to an embodiment, the cover portion C may include a protruding shape. For example, the cover portion C may include a shape protruding toward the cell assembly 100. Accordingly, the fire extinguishing member 300 may be secured to the vent opening 530 via a protruding shape of the cover portion C. Additionally, since a protruding portion protrudes in a direction toward the cell assembly 100, when the case 330 melts, the fire extinguishing fluid 320 may flow consistently toward the battery cell 110 without scattering in other directions.

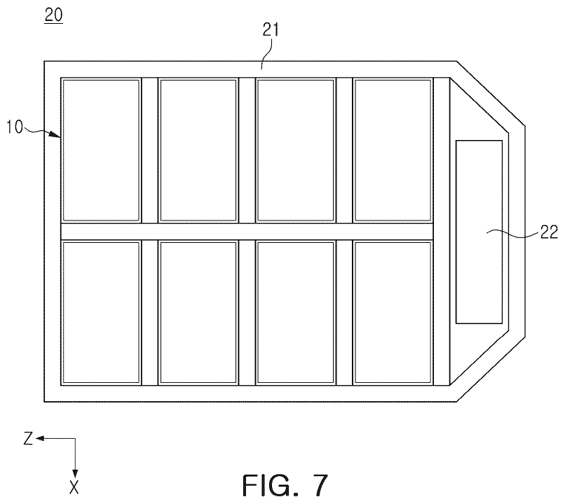

FIG. 7 is a plan view of a battery pack 20 according to an embodiment.

The description of the battery module 10 of FIGS. 1 to 6 may also be applied to the battery module 10 of FIG. 7.

Referring to FIG. 7, the battery pack 20 according to the present disclosure may include a plurality of battery modules 10 and a pack housing 21 accommodating the plurality of battery modules 10.

The pack housing 21 may include an accommodating space in which the battery modules 10 are disposed. The accommodating space of the pack housing 21 may be divided into a plurality of spaces by partition walls.

The battery pack 20 may include a battery controller 22 for controlling the battery modules 10. The battery controller 22 may be disposed within the pack housing 21. The battery controller 22 may include a battery management system (BMS). For example, the battery controller 22 may be electrically connected to the battery module 10. Since the configuration of the battery controller 22 is known in various forms, a detailed description will be omitted.

The explanation described above is merely an example of applying the principles of the present disclosure, and other components may be included without departing from the scope of the present disclosure. Furthermore, some components of the above-described embodiments may be omitted, and the embodiments may be implemented in combination with each other.

What is claimed is:

1. A battery module, comprising:
a cell assembly including a plurality of battery cells;
a housing including a first housing covering the cell assembly and a second housing in which the cell assembly is disposed; and
a fire extinguishing member disposed on one surface of the first housing,
wherein the first housing includes a vent opening for discharging gas generated by the cell assembly, and
the fire extinguishing member covers at least a portion of the vent opening.

2. The battery module of claim 1, wherein the vent opening includes a first portion not covered by the fire extinguishing member and a second portion covered by the fire extinguishing member.

3. The battery module of claim 1, wherein the fire extinguishing member includes:
a case in which an internal space is formed; and
a fire extinguishing fluid accommodated in the internal space.

4. The battery module of claim 3, wherein the case is formed of a material having a melting point of 100° C. or higher.

5. The battery module of claim 3, wherein the fire extinguishing fluid includes at least one of potassium carbonate, ammonium carbonate, urea, first ammonium phosphate, second ammonium phosphate, third ammonium phosphate, or purified water.

6. The battery module of claim 1, wherein the fire extinguishing member includes:
a body portion that does not cover the vent opening; and
a cover portion connected to the body portion and covering the vent opening,
wherein a thickness of one surface of the cover portion facing the cell assembly is thinner than a thickness of the other surface thereof.

7. The battery module of claim 6, wherein a length of the cover portion in a second direction, perpendicular to a first direction in which battery cells of the cell assembly are arranged, is less than a length of the vent opening in the second direction.

8. The battery module of claim 6, wherein the cover portion has a shape protruding in a direction facing the cell assembly.

9. The battery module of claim 1, wherein the vent opening includes a pair of vent openings spaced apart from each other in a second direction, perpendicular to a first direction in which battery cells of the cell assembly are arranged in the first housing.

10. The battery module of claim 9, wherein the vent opening is disposed adjacently to an electrode tab of the cell assembly in the first housing.

11. The battery module of claim 1, wherein the vent opening has a shape extending in a first direction in which battery cells of the cell assembly are arranged.

12. A battery pack, comprising:
at least one battery module; and
a pack housing accommodating the battery module,
wherein the at least one battery module includes:
a cell assembly including a plurality of battery cells;
a housing including a first housing covering the cell assembly and a second housing in which the cell assembly is disposed; and
a fire extinguishing member disposed on one surface of the first housing,
wherein the first housing includes a vent opening for discharging gas generated by the cell assembly, and
the fire extinguishing member covers a portion of the vent opening.

13. The battery pack of claim 12, wherein the fire extinguishing member includes:
a case in which an internal space is formed; and
a fire extinguishing fluid accommodated in the internal space.

14. The battery pack of claim 12, further comprising a battery controller connected to the at least one battery module.

15. The battery pack of claim 12, wherein the pack housing includes at least one frame that partitions a space in which the at least one battery module is accommodated into a plurality of spaces, and
wherein the pack housing accommodates a plurality of battery modules.
